(19) United States
(12) Patent Application Publication
(10) Pub. No.: US 2017/0221481 A1
(43) Pub. Date: Aug. 3, 2017

(54) DATA STRUCTURE, INTERACTIVE VOICE RESPONSE DEVICE, AND ELECTRONIC DEVICE

(71) Applicant: Sharp Kabushiki Kaisha, Sakai City, Osaka (JP)

(72) Inventor: Kohji FUKUNAGA, Sakai City (JP)

(21) Appl. No.: 15/328,169

(22) PCT Filed: Oct. 8, 2015
(86) PCT No.: PCT/JP2015/078633

§ 371 Date: Jan. 23, 2017

(30) Foreign Application Priority Data
Aug. 20, 2014 (JP) 2014-167856

(51) Int. Cl. G10L 15/22; G10L 13/08; G10L 15/08; G10L 15/30

(52) U.S. Cl. CPC G10L 15/22; G10L 15/30; G10L 13/08; G10L 15/08; G10L 2015/088

(57) ABSTRACT

According to an aspect of the present invention, it is possible to continue an interaction at an appropriate timing without the need for a high processing capacity, even in a case where a topic of a conversation is changed. A data structure in accordance with an aspect of the present invention is a data structure including a set of pieces of information, the set of pieces of information at least including: an utterance content (Speak) which is outputted with respect to a user; a response content (Return) which matches the utterance content and causes a conversation to be held; and attribute information (Entity) indicative of an attribute of the utterance content.

### TECHNICAL FIELD

The present invention relates to a voice interactive device which carries out (i) speech recognition and (ii) speech synthesis so as to convert a content of a text into a voice. In particular, the present invention relates to a data structure of data used by a voice interactive device for a voice interaction.

### BACKGROUND ART

A voice interactive system (IVR: Interactive Voice Response), which carries out (i) speech recognition (ASR: Automatic Speech Recognition) and (ii) speech synthesis (TTS: Text To Speech) so as to convert a content of a text into a voice, has been a target of a study or a target of commercialization for a long time. The voice interactive system is considered to be one of user interfaces (I/F) between a user and an electronic device. However, unlike a mouse and a keyboard each of which is generally used as a user I/F, the voice interactive system is currently not in widespread use.

One of reasons why the voice interactive system is not in widespread use is considered to be as follows. That is, it is expected that, with the same level of quality and at the same level of response timing as those of a conversation held between humans, an electronic device receives a voice input and makes a voice response. In order to meet such an expectation, it is necessary that the electronic device carry out, within at least a few seconds, (i) a process of receiving human speech as a sound wave, determining a word, a context, and the like from the sound wave, and understanding a meaning of the human speech and (ii) a process of specifying or creating a sentence, appropriate for the meaning, from candidates in accordance with a situation of the electronic device itself or an environment surrounding the electronic device itself and outputting the sentence as a sound wave. Under the circumstances, the electronic device needs to, not only ensure quality of a content of a conversation, but also carry out an extraordinary large amount of calculation and have an extraordinary large memory.

In view of the above, the following solution is suggested. That is, it is suggested to (i) define a data system in which a content of a conversation which content matches an assumed use application is written and (ii) develop, with use of the data system, a proper interactive system which does not exceed a limit of a processing capacity of an electronic device. For example, VoiceXML (VXML), which is a markup language used to write a conversation pattern for a voice interaction, allows a proper interactive system to be developed in a use application such as telephone answering. Extensible Interaction Sheet Language (XISL), which is used to define data in consideration of not only a context but also non-linguistic information such as a tone of a voice, allows a smooth interactive system to be developed. Furthermore, Patent Literature 1 discloses a method of searching, at a high speed, a database for a content of a conversation. Patent Literature 2 discloses a method of, with use of an electronic device, effectively (i) analyzing an inputted voice and (ii) generating a content of a response.

### CITATION LIST

### Patent Literature

### [Patent Literature 1]

Japanese Patent No. 4890721 (registered on Dec. 22, 2011)

### [Patent Literature 2]

Japanese Patent No. 4073668 (registered on Feb. 1, 2008)

### SUMMARY OF INVENTION

### Technical Problem

A conventional voice interactive system is based on the premise that a user has a specific purpose at a time when the user starts to have a voice interaction with the voice interactive system. A data system in which a conversation is written is optimized also based on such a premise. For example, in a case of VoiceXML, a conversation between a voice interactive system and a user is divided into subroutines. For example, a conversation written in VoiceXML for search for an address is arranged such that a postal code, a prefecture, and the like are asked one by one. Such a data structure is not suitable for a case where a topic of a conversation is changed. In a general man-to-man communication, a conversation is held in a chat style in which a topic of the conversation is constantly changed. In this case, VoiceXML allows only part of the whole communication to be realized.

Patent Literature 1 suggests, as a solution of the foregoing problem, a method in which a voice interactive system jumps to, at a high speed, a specific conversation routine with use of a search key referred to as a marker. However, according to the method, only conversation data to which a marker is set can be retrieved. Therefore, the method is not suitable for a case where a topic of a conversation is changed. Besides, Patent Literature 1 does not mention a data structure itself of data used for a voice interaction.

Patent Literature 2 suggests a method in which, in order that a user's intention is understood, (i) voice information is converted into a text, (ii) a semantic analysis is carried out with respect to the text, (iii) attribute information based on a result of the semantic analysis is added to the text, and (iv) information thus obtained is transferred to an external computer having a high processing capacity. However, since this method is premised on serial processing, it is difficult to realize an interaction at a comfortable timing, unless a computer having a high processing capacity is used.

The present invention has been made in view of the above problems, and the object of the present invention is to provide (i) a data structure of data used for a voice interaction, the data structure making it possible to have the voice interaction at a comfortable timing without the need for a high processing capacity and making it possible to continue the voice interaction even in a case where a topic of a conversation is changed, (ii) a voice interactive device, and (iii) an electronic device.

### Solution to Problem

In order to attain the above object, a data structure in accordance with an aspect of the present invention is a data structure of data used for a voice interaction, the data structure including a set of pieces of information, the set of pieces of information at least including: an utterance content which is outputted with respect to a user; a response content which matches the utterance content and causes a conversation to be held; and attribute information indicative of an attribute of the utterance content.

A voice interactive device in accordance with an aspect of the present invention is a voice interactive device which has a voice interaction with a user, the voice interactive device including: an utterance content specifying section which analyzes a voice uttered by a user and specifies an utterance content; a response content obtaining section which obtains a response content from interaction data registered in advance, the response content matching the utterance content, which the utterance content specifying section has specified, and causing a conversation to be held; and a voice data outputting section which outputs, as voice data, the response content that the response content obtaining section has obtained, the interaction data having a data structure in which a set of pieces of information is contained, the set of pieces of information at least including: the utterance content which is inputted by the user; the response content which matches the utterance content and causes the conversation to be held; and attribute information indicative of an attribute of the utterance content.

### Advantageous Effects of Invention

According to an aspect of the present invention, it is possible to have an interaction at a comfortable timing without the need for a high processing capacity, and possible to continue the interaction even in a case where a topic of a conversation is changed.

### BRIEF DESCRIPTION OF DRAWINGS

FIG. 1 is a block diagram schematically illustrating a configuration of a voice interactive system in accordance with Embodiment 1 of the present invention.

FIG. 2 is a view illustrating a data structure of data used, for interactive processing, by the voice interactive system illustrated in FIG. 1.

FIG. 3 is a view illustrating data A1, illustrated in FIG. 2, in an interaction markup language format.

FIG. 4 is a view illustrating data A2, illustrated in FIG. 2, in an interaction markup language format.

FIG. 5 is a view illustrating data A3, illustrated in FIG. 2, in an interaction markup language format.

FIG. 6 is a view illustrating data A4, illustrated in FIG. 2, in an interaction markup language format.

FIG. 7 is a sequence diagram illustrating a flow of interactive processing carried out by the voice interactive system illustrated in FIG. 1.

FIG. 8 is a sequence diagram illustrating a flow of interactive processing carried out by the voice interactive system illustrated in FIG. 1.

FIG. 9 is a sequence diagram illustrating a flow of interactive processing carried out by the voice interactive system illustrated in FIG. 1.

FIG. 10 is a sequence diagram illustrating a flow of interactive processing carried out by the voice interactive system illustrated in FIG. 1.

FIG. 11 is a sequence diagram illustrating a flow of interactive processing carried out by the voice interactive system illustrated in FIG. 1.

FIG. 12 is a block diagram schematically illustrating a configuration of a voice interactive system in accordance with Embodiment 2 of the present invention.

FIG. 13 is a sequence diagram illustrating a flow of interactive processing carried out by the voice interactive system illustrated in FIG. 12.

FIG. 14 is a sequence diagram illustrating a flow of interactive processing carried out by the voice interactive system illustrated in FIG. 12.

### DESCRIPTION OF EMBODIMENTS

### Embodiment 1

The following description will discuss, in detail, Embodiment 1 of the present invention.

(Overview of Voice Interactive System)

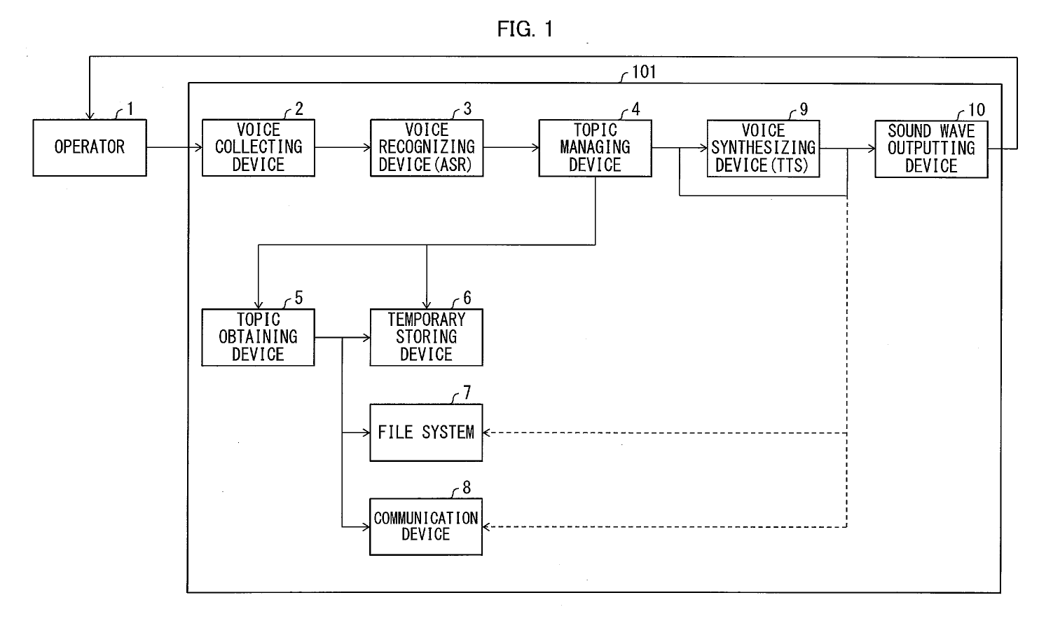

FIG. 1 is a block diagram schematically illustrating a configuration of a voice interactive system (voice interactive device) 101 in accordance with Embodiment 1 of the present invention. As illustrated in FIG. 1, the voice interactive system 101 is a system which vocally interacts with an operator (user) 1 who operates the system. The voice interactive system 101 includes a voice collecting device 2, a voice recognizing device (ASR) 3, a topic managing device (utterance content specifying section) 4, a topic obtaining device (response content obtaining section) 5, a temporary storing device 6, a file system 7, a communication device 8, a voice synthesizing device (TTS) 9, and a sound wave outputting device 10.

Note that the topic managing device 4, the voice synthesizing device 9, and the sound wave outputting device 10 constitutes a voice data outputting section which outputs, as a voice, topic data that the topic obtaining device 5 has obtained. Note also that the voice synthesizing device 9 can be omitted. Reasons why the voice synthesizing device 9 can be omitted will be described later.

The voice collecting device 2 collects a voice uttered by the operator 1, and converts the voice thus collected into electronic data in wave form (waveform data). The voice collecting device 2 transmits such electronic waveform data thus converted to the voice recognizing device 3 which is provided downstream of the voice collecting device 2.

The voice recognizing device 3 converts, into text data, electronic waveform data transmitted from the voice collecting device 2. The voice recognizing device 3 transmits the text data thus converted to the topic managing device 4 which is provided downstream of the voice recognizing device 3.

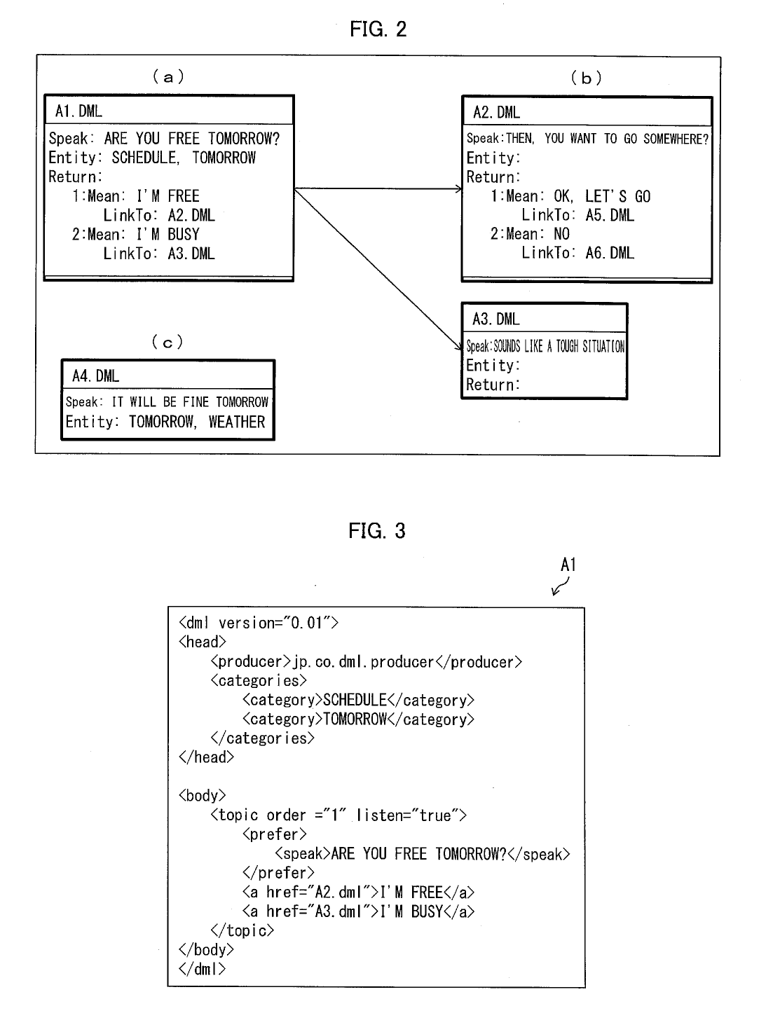

The topic managing device 4 analyzes text data transmitted from the voice recognizing device 3, specifies a content of an utterance inputted by the operator 1 (utterance content, analysis result), and obtains data for interaction (interaction data) (e.g., data illustrated in FIG. 2) which data indicates a content of a response (response content) to the utterance. Note that the response content matches the utterance content and causes a conversation to be held. How to obtain the interaction data will be described later in detail.

The topic managing device 4 extracts, from the interaction data thus obtained, text data or voice data (PCM data) each of which corresponds to the response content. In a case where the topic managing device 4 extracts text data, the topic managing device 4 transmits the text data to the voice synthesizing device 9 which is provided downstream of the topic managing device 4. In a case where the topic managing device 4 extracts voice data, the topic managing device 4 transmits registration address information on the voice data, to the sound wave outputting device 10 which is provided downstream of the topic managing device 4. Note, here, that, in a case where the voice data is stored in the file system 7, the registration address information indicates an address, in the file system 7, of the voice data, whereas, in a case where the voice data is stored in an external device (not illustrated) via the communication device 8, the registration address information indicates an address, in the external device, of the voice data.

The voice synthesizing device 9 is a Text to Speech (TTS) device, and converts, into PCM data, text data transmitted from the topic managing device 4. The voice synthesizing device 9 transmits the PCM data thus converted to the sound wave outputting device 10 which is provided also downstream of the voice synthesizing device 9.

The sound wave outputting device 10 outputs, as a sound wave, PCM data transmitted from the voice synthesizing device 9. Note that, as used herein, a sound wave means a sound which a human can recognize. The sound wave outputted from the sound wave outputting device 10 indicates a response content which matches an utterance content inputted by the operator 1. This causes a conversation to be held between the operator 1 and the voice interactive system 101.

As has been described, in some cases, the sound wave outputting device 10 receives, from the topic managing device 4, registration address information on PCM data. In this case, the sound wave outputting device 10 (i) obtains, in accordance with the registration address information thus received, the PCM data stored in any one of the file system 7 and the external device which is connected to the voice interactive system 101 via the communication device 8 and (ii) outputs the PCM data as a sound wave.

(Obtainment of Interaction Data)

The topic managing device 4 obtains interaction data with use of the topic obtaining device 5, the temporary storing device 6, the file system 7, and the communication device 8.

The temporary storing device 6 is constituted by a storing device, such as an RAM, which allows reading/writing to be carried out at a high speed, and temporarily stores therein an analysis result transmitted from the topic managing device 4.

The file system 7 retains therein, as a file, interaction data which contains, as persistent information, text data (data in an interaction markup language format (interaction-markup-language data)) and/or voice data (data in a PCM format (PCM data)). The text data (interaction-markup-language data) will be later described in detail.

The communication device 8 is connected to a communication network (network) such as the Internet, and obtains interaction-markup-language data and PCM data each of which is registered in the external device (device provided outside the voice interactive system 101).

Note, here, that topic managing device 4 transmits, to the topic obtaining device 5, an instruction to obtain interaction data, and temporarily stores an analysis result in the temporary storing device 6.

The topic obtaining device 5 obtains, in accordance with an analysis result stored in the temporary storing device 6, interaction data from the file system 7 or from the external device, which is connected to the communication device 8 via the communication network. The topic obtaining device 5 transmits the interaction data thus obtained to the topic managing device 4.

(Interaction-Markup-Language Data)

FIG. 2 illustrates an example data structure of interaction data (A1 through A4). The interaction data contains a minimum unit of an interaction, that is, indicates a combination of an utterance content and a response content which is assumed from the utterance content (assumed response content).

For example, the interaction data A1 contains a set of pieces of information, that is, “Speak: Are you free tomorrow?,” “Return: 1: Mean: I'm free, 2: Mean: I'm busy,” and “Entity: schedule, tomorrow” (see (a) of FIG. 2). Note that (i) “Speak: Are you free tomorrow?” is information indicative of an utterance content which is outputted with respect to the operator 1 (an assumed response content), (ii) “Return: 1: Mean: I'm free, 2: Mean: I'm busy” is information indicative of assumed response contents (adjacency pairs) each of which matches the utterance content and causes a conversation to be held, and (iii) “Entity: schedule, tomorrow” is attribute information indicative of an attribute of the utterance content. A detailed data structure of the interaction data A1 is, for example, one as illustrated in FIG. 3. That is, according to an example illustrated in FIG. 3, the pieces of information are written in extended XML in the interaction data A1.

For example, as has been described, that the topic managing device 4 extracts text data from interaction data means that the topic managing device 4 extracts a content “Are you free tomorrow?” of the information “Speak: Are you free tomorrow?” contained in the interaction data A1. The interaction data A1 can contain, in addition to the information “Speak: Are you free tomorrow?,” information on an address at which voice data, indicative of “Are you free tomorrow?,” is registered (registration address information) (not illustrated).

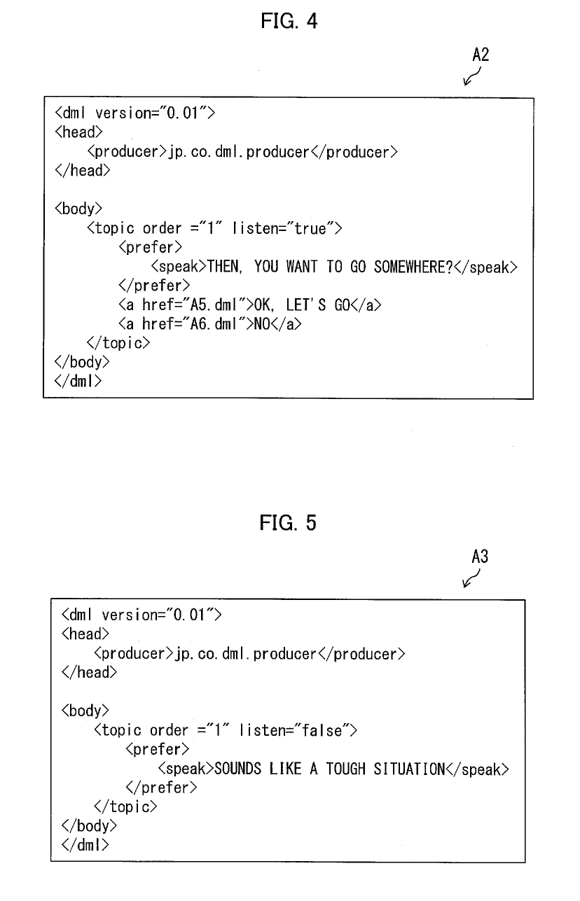

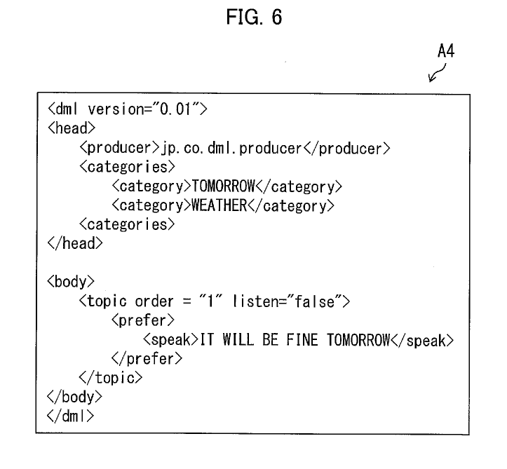

The interaction data A2 and the interaction data A3, each illustrated in (b) of FIG. 2, and the interaction data A4 illustrated in (c) of FIG. 2 are each different, in contained information, from the interaction data A1, but are each identical, in data structure, to the interaction data A1. Here, a detailed data structure of the interaction data A2 is, for example, one as illustrated in FIG. 4. A detailed data structure of the interaction data A3 is, for example, one as illustrated in FIG. 5. A detailed data structure of the interaction data A4 is, for example, one as illustrated in FIG. 6.

Note that, in the interaction data A1, the interaction data A2 is written as a link which is referred to in a case where “1: Mean: I'm free” is returned with respect to “Speak: Are you free tomorrow?,” whereas the interaction data A3 is written as a link which is referred to in a case where “2: Mean: I'm busy” is returned with respect to “Speak: Are you free tomorrow?.”

Therefore, in a case where the operator 1 responds to the utterance, that is, “Are you free tomorrow?” by “I'm free,” the interaction data A2, in which “Speak: Then, you want to go somewhere?” is written, is referred to so that a conversation is held. In a case where the operator 1 responds to the utterance, that is, “Are you free tomorrow?” by “I'm busy,” the interaction data A3, in which “Speak: Sounds like a tough situation” is written, is referred to so that a conversation is held.

The interaction data A1 thus contains data structure specifying information (e.g., “Link To: A2.DML”) which specifies another data structure (e.g., interaction data A2) in which another utterance content (e.g., “Speak: Then, you want to go somewhere?”) is registered, the another utterance content being relevant to one (adjacency pair, e.g., 1: Mean: I'm free) of the assumed response contents each of which matches the utterance content (e.g., “Speak: Are you free tomorrow?”) and causes a conversation to be held. This allows a conversation to be continued.

Furthermore, in the interaction data A2, the interaction data A5 is written as a link which is referred to in a case where “1: Mean: OK, Let's go” is returned with respect to “Speak: Then, you want to go somewhere?,” whereas the interaction data A6 is written as a link which is referred to in a case where “2: No” is returned with respect to “Speak: Then, you want to go somewhere?.” This allows the conversation to be further continued.

By the way, in a case where the operator 1 responds to the utterance with use of one of the adjacency pairs, this causes a conversation to be held. In a case where the operator 1 responds to the utterance without use of any one of the adjacency pairs, this may cause a change in topic of a conversation and may ultimately cause the conversation not to be continued.

In view of this, as in the interaction data A1 illustrated in (a) of FIG. 2, interaction data in accordance with Embodiment 1 of the present invention contains attribute information (e.g., “Entity: schedule, tomorrow”) indicative of an attribute of an utterance content. In a case where a topic of a conversation is likely to be changed, that is, in a case where the operator 1 responds to an utterance without use of an adjacency pair, use of the attribute information makes it possible to obtain interaction data which contains an appropriate response content.

The attribute information is preferably made of a keyword in accordance with which another response content, further assumed from the utterance content, is specified. For example, in the interaction data A1 illustrated in (a) of FIG. 2, keywords “schedule, tomorrow” are written as the attribute information indicative of the attribute of “Speak: Are you free tomorrow?,” which indicates the utterance content.

Therefore, interaction data is obtained which contains an utterance content and which includes at least any one of the keywords “schedule, tomorrow” that are written as the attribute information. For example, it is assumed that the voice interactive system 101 asks “Are you free tomorrow?” in accordance with the interaction data A1 and then the operator 1 responds to “Are you free tomorrow?” by “What will the weather be like tomorrow?” In this case, the file system 7 is searched with use of keywords “tomorrow” and “weather”, and the interaction data A4, in which “Entity: tomorrow, weather” is written (see (c) of FIG. 2), is found. Then, the voice interactive system 101 speaks a content “It will be fine tomorrow” of “Speak: It will be fine tomorrow” written in the interaction data A4. In this manner, even in a case where the operator 1 responds to an utterance, outputted by the voice interactive system 101, without use of an adjacency pair, the voice interactive system 101 is capable of obtaining a response content appropriate for such an utterance content inputted by the operator 1. This allows a conversation to be continued without causing a change in topic of the conversation. Note that, in a case where interaction data is one that is used in the middle of a conversation, attribute information is not always needed and can be omitted.

Here, the following five sequences of interactive processing carried out by the voice interactive system 101 will be described below.

(Sequence 1: Basic Pattern)

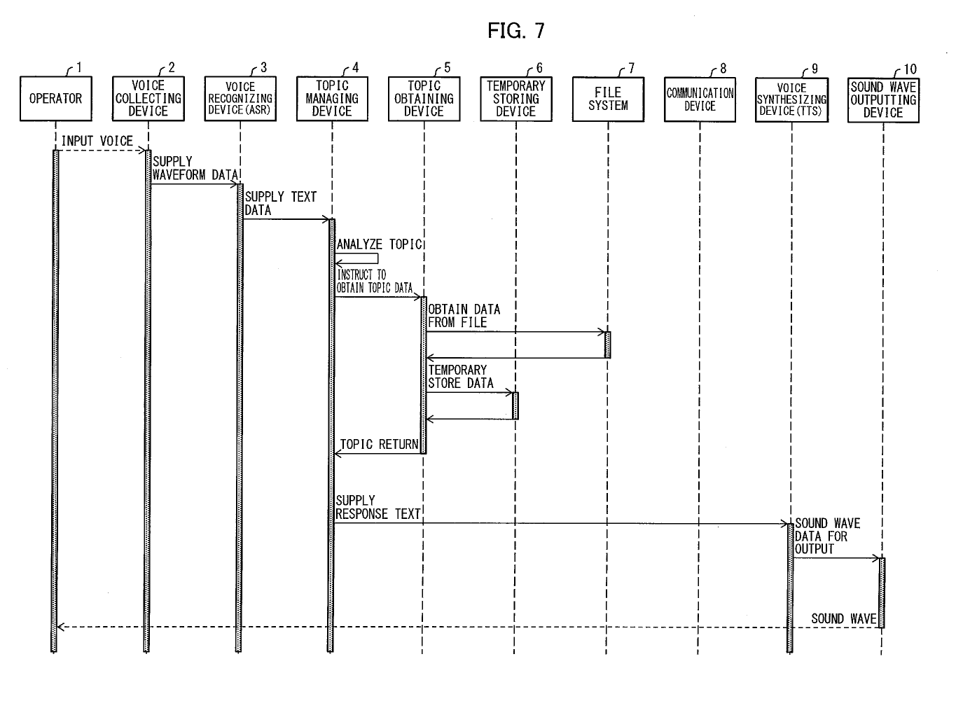

First, a sequence of interactive processing which the voice interactive system 101 starts in response to the operator 1 speaking to the voice interactive system 101 will be described below with reference to FIG. 7.

The voice collecting device 2 converts, into waveform data, a voice inputted by the operator 1 speaking to the voice interactive system 101, and supplies the waveform data to the voice recognizing device 3.

The voice recognizing device 3 converts the waveform data thus received into text data, and supplies the text data to the topic managing device 4.

The topic managing device 4 analyzes, from the text data thus received, a topic of an utterance content inputted by the operator 1, and instructs the topic obtaining device 5 to obtain topic data (interaction data) in accordance with such an analysis result.

The topic obtaining device 5 obtains topic data from the file system 7 in accordance with an instruction given by the topic managing device 4, and temporarily stores the topic data in the temporary storing device 6. After obtaining the topic data, the topic obtaining device 5 supplies the topic data to the topic managing device 4 (topic return). Note, here, that the topic data obtained by the topic obtaining device 5 contains text data (response text).

The topic managing device 4 extracts the text data (response text) from the topic data which the topic obtaining device 5 has obtained, and supplies the text data to the voice synthesizing device 9.

The voice synthesizing device 9 converts the response text thus received into sound wave data (PCM data) for output, and supplies the sound wave data to the sound wave outputting device 10.

The sound wave outputting device 10 outputs, with respect to the operator 1, the sound wave data thus received, as a sound wave.

The above sequence allows a conversation to be held between the operator 1 and the voice interactive system 101.

(Sequence 2: Preparation for Continuation of Conversation)

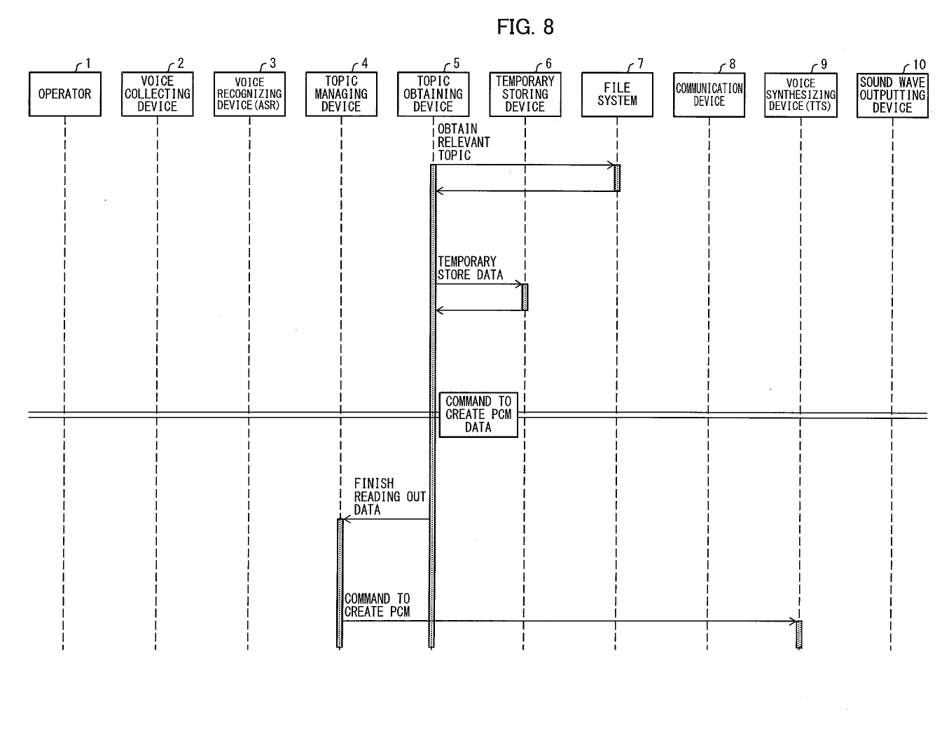

Next, a process of, after responding to the operator 1 by the sequence illustrated in FIG. 7, preparing to continue a conversation will be described below with reference to a sequence illustrated in FIG. 8.

According to the sequence illustrated in FIG. 8, the topic obtaining device 5 obtains, from the file system 7, topic data relevant to topic data which the topic obtaining device 5 has already obtained, and temporarily stores such relevant topic data in the temporary storing device 6. Here, assuming that the interaction data A1 illustrated in FIG. 2 is the topic data which the topic obtaining device 5 has already obtained, each of the interaction data A2 and the interaction data A3, each of which is written as a link in the interaction data A1, is the relevant topic data. Note that, in a case where the topic obtaining device 5 reads out the interaction data A2, the topic obtaining device 5 also reads out the interaction data A5 and the interaction data A6 each of which is written as a link in the interaction data A2.

After obtaining all pieces of relevant topic data and temporarily storing the all pieces of relevant topic data in the temporary storing device 6, the topic obtaining device 5 notifies the topic managing device 4 that the topic obtaining device 5 has finished reading out the all pieces of relevant topic data.

In a case where the topic obtaining device 5 finishes reading out the all pieces of relevant topic data, the topic managing device 4 commands the voice synthesizing device 9 to create PCM data on each of the all pieces of relevant topic data which the topic obtaining device 5 has read out.

By thus obtaining relevant topic data in advance, it is possible to continue a conversation at a proper pace.

Furthermore, since pre-reading of interaction data is carried out (that is, the interaction data A2 and the interaction data A3, each of which is written as a link in the interaction data A1, are read out when the interaction data A1 is read out), it is not necessary to carry out serial processing (that is, a process of obtaining interaction data, creating PCM data, and then outputting a sound wave). It is therefore possible to use a CPU which is not high in processing capacity.

(Sequence 3: Continuation of Conversation)

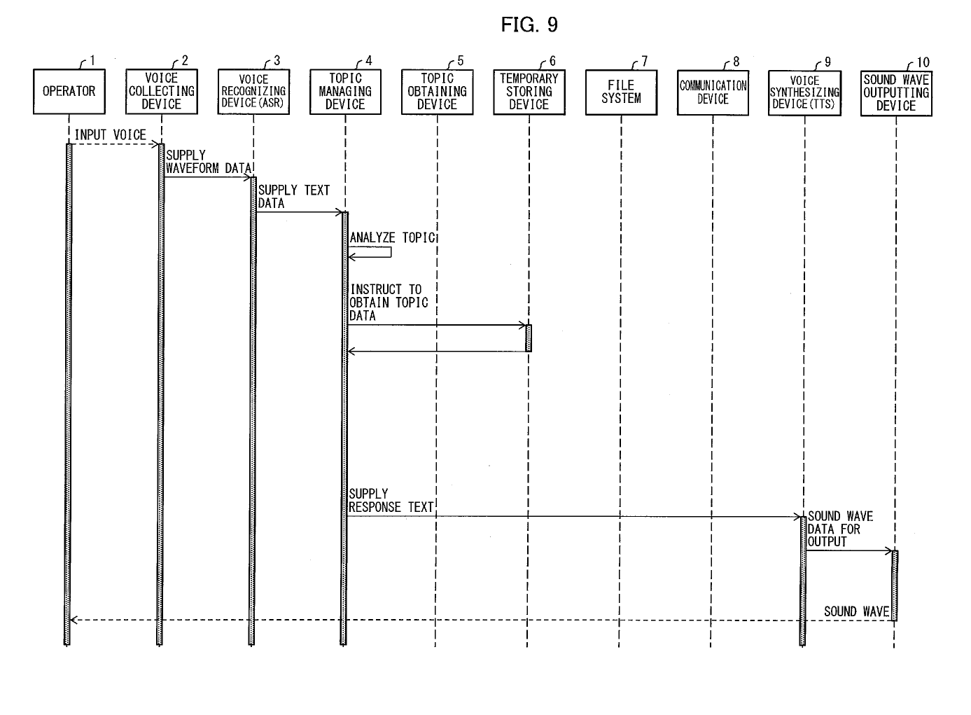

Next, a process of, after obtaining relevant topic data by the sequence illustrated in FIG. 8, responding to the operator 1 so as to continue a conversation will be described below with reference to a sequence illustrated in FIG. 9.

The sequence illustrated in FIG. 9 is basically identical to the sequence illustrated in FIG. 7, except that the topic obtaining device 5 is not used in the sequence illustrated in FIG. 9, because topic data has been already obtained and temporarily stored in the temporary storing device 6.

That is, the topic managing device 4 reads out the topic data (interaction data) from the temporary storing device 6, extracts text data (response text) from the topic data, and commands the voice synthesizing device 9 to create PCM data on the text data. Note that the topic managing device 4 sequentially analyzes an utterance content, and sequentially reads out, in accordance with such an analysis result, topic data stored in the temporary storing device 6.

The voice synthesizing device 9 converts the response text thus received into sound wave data (PCM data) for output, and supplies the sound wave data to the sound wave outputting device 10.

The sound wave outputting device 10 outputs, with respect to the operator 1, the sound wave data thus received, as a sound wave.

This process is carried out until no topic data is left in the temporary storing device 6.

Note that the topic managing device 4 can instruct the voice synthesizing device 9 to convert, into respective pieces of PCM data, all pieces of topic data stored in the temporary storing device 6. In this case, the voice synthesizing device 9 temporarily stores the pieces of PCM data thus created in the temporary storing device 6. The voice synthesizing device 9 reads out necessary one of the pieces of PCM data in accordance with an instruction given by the topic managing device 4, and transmits the necessary one of the pieces of PCM data to the sound wave outputting device 10.

By thus converting all pieces of relevant topic data into respective pieces of PCM data in advance, it is possible to quickly respond to the operator 1 by time that it takes to convert the all pieces of relevant topic data into the respective pieces of PCM data.

(Sequence 4: Direct Reproduction)

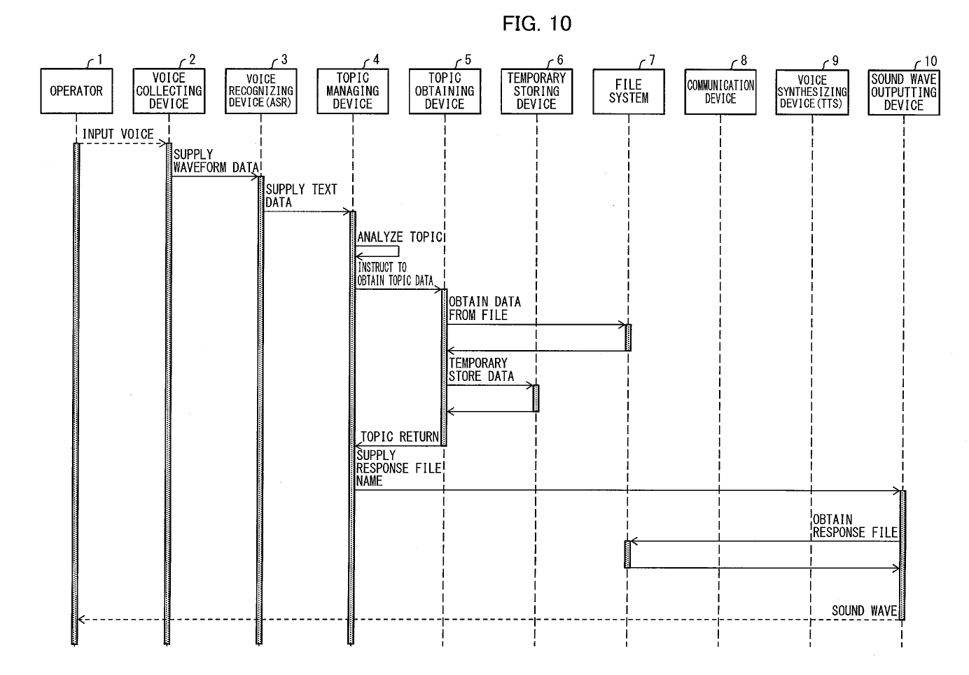

According to the sequences 1 through 3, the voice synthesizing device 9 converts topic data into PCM data, and the sound wave outputting device 10 receives the PCM data from the voice synthesizing device 9. Here, a process carried out in a case where the sound wave outputting device 10 directly reproduces topic data without involvement from the voice synthesizing device 9 will be described with reference to a sequence illustrated in FIG. 10.

The sequence illustrated in FIG. 10 is basically identical to the sequence illustrated in FIG. 7, except that the sound wave outputting device 10 directly reproduces topic data without involvement from the voice synthesizing device 9.

In this sequence, (i) PCM data and (ii) topic data which contains a response file name (registration address information) associated with the PCM data are stored in the file system 7.

Unlike the sequence illustrated in FIG. 7, the topic obtaining device 5 specifies, in accordance with an analysis result obtained by the topic managing device 4, topic data stored in the file system 7, and obtains a response file name associated with the topic data thus specified.

The topic obtaining device 5 temporarily stores the response file name thus obtained in the temporary storing device 6, and carries out a topic return with respect to the topic managing device 4.

In a case where the topic return is carried out, the topic managing device 4 supplies, to the sound wave outputting device 10, the response file name which the topic obtaining device 5 has obtained.

The sound wave outputting device 10 obtains, from the file system 7, PCM data which is associated with the response file name thus received, and outputs the PCM data as a sound wave with respect to the operator 1.

(Sequence 5)

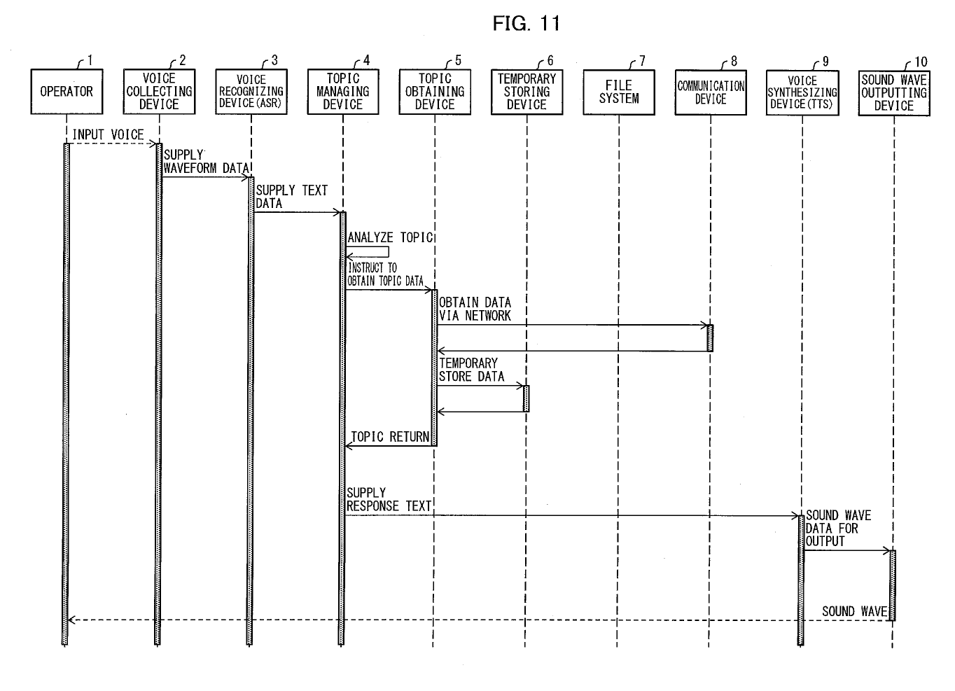

According to the sequences 1 through 4, topic data is obtained from the file system 7. Here, a process carried out in a case where topic data is obtained from an external device, for example, the external device which is connected to the voice interactive system 101 via the communication network will be described below with reference to a sequence illustrated in FIG. 11.

The sequence illustrated in FIG. 11 is basically identical to that illustrated in FIG. 7, except that topic data is obtained, not from the file system 7, but from the external device connected to the communication network. In this case, the topic obtaining device 5 obtains, via the communication device 8, the topic data from the external device (not illustrated) connected to the communication network.

In a case where voice data (PCM data) is obtained from the external device, the topic managing device 4 obtains registration address information on the voice data. Therefore, in a case where the voice data is obtained from the external device, the topic managing device 4 transmits the registration address information to the sound wave outputting device 10. The sound wave outputting device 10 obtains, in accordance with the registration address information thus received, the voice data from the external device via the communication device 8, and outputs the voice data as a sound wave with respect to the operator 1.

As has been described, according to the voice interactive system 101 in accordance with Embodiment 1, since interaction data is pre-read, it is possible to use a CPU which is not high in processing capacity. Moreover, since the interaction data contains attribute information indicative of an attribute of an utterance content, it is possible to obtain appropriate interaction data in accordance with the attribute information, even in a case where a topic of a conversation is changed. As a result, it is possible to continue the conversation.

Note, here, that, according to each of the above sequences, a timing at which the sound wave outputting device 10 outputs a sound wave with respect to the operator 1 is not specified. That is, the sound wave outputting device 10 outputs the sound wave when receiving an instruction from the topic managing device 4 or from the voice synthesizing device 9.

Therefore, time (response time), from when the operator 1 speaks to the voice interactive system 101 to when the sound wave outputting device 10 outputs the sound wave indicative of a response content, varies depending on a processing capacity of the voice interactive system 101. For example, in a case where the voice interactive system 101 has a higher processing capacity, the response time becomes shorter. In a case where the voice interactive system 101 has a lower processing capacity, the response time becomes longer.

By the way, too long response time and too short response time both cause a pace of a conversation to be unnatural. It is therefore important to adjust the response time. In Embodiment 2 below, an example will be described in which the response time is adjusted.

### Embodiment 2

The following description will discuss another embodiment of the present invention. Note that, for convenience, a member having a function identical to that of a member described in Embodiment 1 will be given an identical reference numeral, and a description of the member will be omitted.

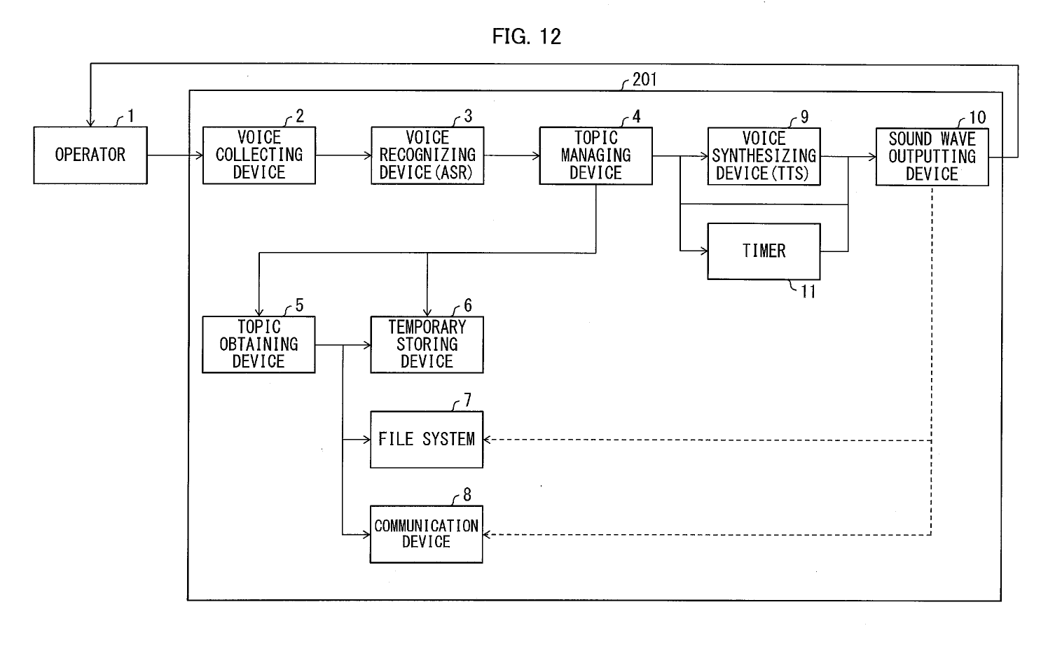

FIG. 12 is a block diagram schematically illustrating a configuration of a voice interactive system (voice interactive device) 201 in accordance with Embodiment 2 of the present invention. The voice interactive system 201 is basically identical, in configuration, to the voice interactive system 101 in accordance with Embodiment 1, except that the voice interactive system 201 includes a timer 11 which is provided between a topic managing device 4 and a sound wave outputting device 10 so as to be parallel to a voice synthesizing device 9 (see FIG. 12). Note that, since the configuration, other than the timer 11, of the voice interactive system 201 is identical to that of the voice interactive system 101 in accordance with Embodiment 1, a description of the configuration, other than the timer 11, will be omitted.

The timer 11 measures time (measured time) that has elapsed from a time point when a voice collecting device 2 collected a voice uttered by an operator 1. The timer 11 instructs the sound wave outputting device 10 to output a sound wave, in a case where given time, inputted by the topic managing device 4, has elapsed. That is, the timer 11 counts (measures) time set in accordance with an output (timer control signal) from the topic managing device 4, and supplies, to the sound wave outputting device 10, a signal indicating that the timer 11 has finished counting such set time (signal indicating that the timer 11 determines that measured time is equal to or longer than preset time).

The sound wave outputting device 10 obtains information on time measured by the timer 11 immediately before the sound wave outputting device 10 outputs voice data. In a case where the sound wave outputting device 10 determines that measured time is equal to or longer than preset time, the sound wave outputting device 10 outputs the voice data immediately after the sound wave outputting device 10 determines that measured time is equal to or longer than preset time. In a case where the sound wave outputting device 10 determines that the measured time is shorter than the preset time, the sound wave outputting device 10 outputs the voice data when the measured time reaches the preset time. That is, in a case where the sound wave outputting device 10 receives, from the timer 11, a signal indicating that the timer 11 has finished counting set time, the sound wave outputting device 10 outputs a sound wave with respect to the operator 1 at that timing (immediately after determination is made). In other words, although the sound wave outputting device 10 receives voice data from the voice synthesizing device 9, the sound wave outputting device 10 stands by without outputting a sound wave until the sound wave outputting device 10 receives, from the timer 11, a signal indicating that the timer 11 has finished counting set time. Note that, in a case where the sound wave outputting device 10 does not receive data, to be outputted, before receiving a signal indicating that the timer 11 has finished counting set time, the sound wave outputting device 10 outputs a sound wave when the sound wave outputting device 10 receives the data to be outputted.

By adjusting time set to the timer 11, it is possible to adjust a timing at which the sound wave outputting device 10 outputs a sound wave. The time set to the timer 11 is preferably time which does not cause a feeling of strangeness in a conversation. The time set to the timer 11 is preferably such time that, for example, a response is made within 1.4 seconds on average, more preferably such time that a response is made within approximately 250 milliseconds to 800 milliseconds. Note that the time set to the timer 11 can be changed depending on a situation of the system.

Here, the following two sequences of interactive processing carried out by the voice interactive system 201 will be described below.

(Sequence 6: Basic Pattern of Sound Wave Outputted Timing)

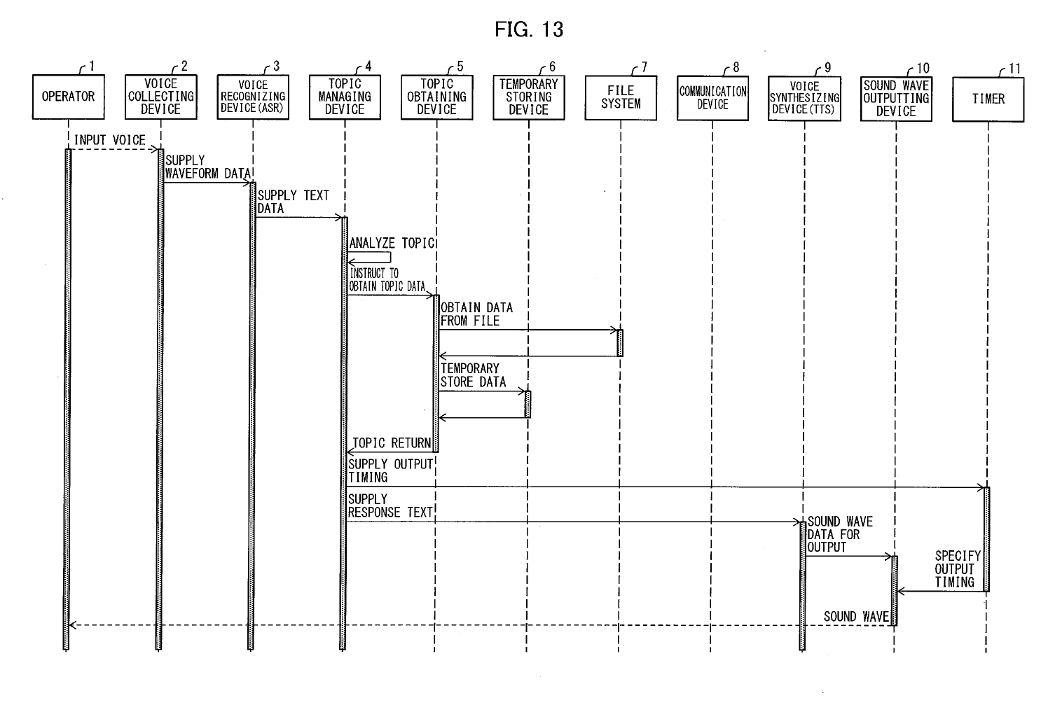

First, a sequence of interactive processing which the voice interactive system 201 starts in response to the operator 1 speaking to the voice interactive system 201 will be described below with reference to FIG. 13. This sequence is substantially identical to the sequence, illustrated in FIG. 7, of Embodiment 1, except that a timing at which the sound wave outputting device 10 outputs a sound wave is controlled with use of the timer 11.

That is, the sequence illustrated in FIG. 13 is identical to that illustrated in FIG. 7 in terms of the following processes: the voice collecting device 2 collects a voice uttered by the operator 1; a topic obtaining device 5 carries out a topic return with respect to the topic managing device 4; the topic managing device 4 supplies, to the voice synthesizing device 9, a response text which the topic obtaining device 5 has obtained; and the voice synthesizing device 9 converts the response text into sound wave data (PCM data) to be outputted, and supplies the sound wave data to the sound wave outputting device 10.

A difference between the voice interactive system 201 and the voice interactive system 101 of Embodiment 1 is that the sound wave outputting device 10 outputs, with respect to the operator 1, a sound wave in accordance with a signal supplied from the timer 11, that is, a signal for specifying a timing at which the sound wave outputting device 10 outputs the sound wave.

(Sequence 7: Continuation of Conversation)

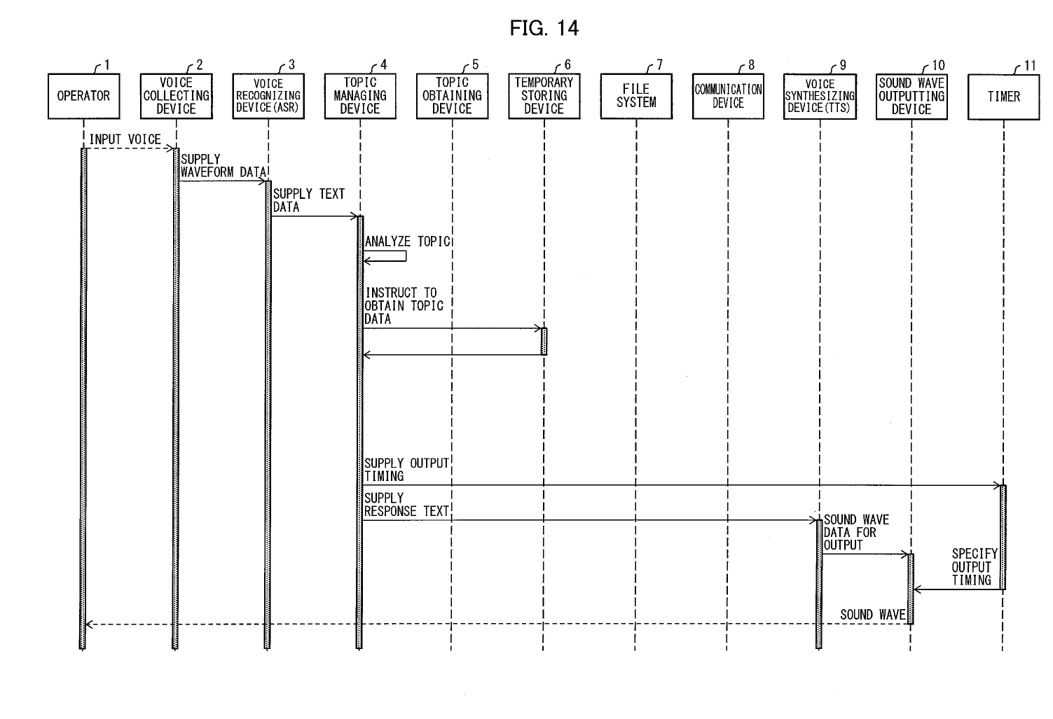

Next, a process of responding to the operator 1 so as to continue a conversation will be described below with reference to a sequence illustrated in FIG. 14.

The sequence illustrated in FIG. 14 is basically identical to the sequence illustrated in FIG. 13, except that the topic obtaining device 5 is not used in the sequence illustrated in FIG. 14, because topic data has been already obtained and temporarily stored in a temporary storing device 6.

That is, the topic managing device 4 reads out the topic data from the temporary storing device 6, extracts text data (response text) from the topic data, and commands the voice synthesizing device 9 to create PCM data on the text data. The topic managing device 4 sequentially analyzes an utterance content, and sequentially reads out, in accordance with such an analysis result, topic data stored in the temporary storing device 6.

The voice synthesizing device 9 converts the response text thus received into sound wave data (PCM data) for output, and supplies the sound wave data to the sound wave outputting device 10. In a case where the sound wave outputting device 10 receives, from the timer 11, a signal for specifying a timing at which the sound wave outputting device 10 outputs a sound wave, the sound wave outputting device 10 outputs, with respect to the operator 1, the sound wave data thus received, as a sound wave.

This process is carried out until no topic data is left in the temporary storing device 6.

According to the voice interactive system 201 in accordance with Embodiment 2, it is thus possible to bring about effects identical to those brought about by the voice interactive system 101 in accordance with Embodiment 1. Furthermore, it is possible to adjust, with use of the timer, a timing at which the sound wave outputting device 10 outputs a sound wave. This makes it possible to hold a conversation in which a response is made at a natural pace and which does not cause a feeling of strangeness.

### Embodiment 3

The following description will discuss another embodiment of the present invention. Note that, for convenience, a member having a function identical to that of a member described in Embodiment 1 or 2 will be given an identical reference numeral, and a description of the member will be omitted.

An electronic device in accordance with Embodiment 3 includes a voice interactive system 101 illustrated in FIG. 1 or a voice interactive system 201 illustrated in FIG. 12.

Examples of the electronic device encompass: a mobile phone; a smartphone; a robot; a game machine; a toy (such as a stuffed toy); various home appliances (such as a cleaning robot, an air conditioner, a refrigerator, and a washing machine); a personal computer (PC); a cash register; an automatic teller machine (ATM); commercial-use equipment (such as a vending machine); various electronic devices which are assumed to have a voice interaction; and various human-controllable vehicles (such as a car, an airplane, a ship, and a train).

Therefore, according to the electronic device in accordance with Embodiment 3, even in a case where a topic of a conversation is changed, it is possible to continue the conversation. This allows an operator, who operates the electronic device, to have a conversation with the electronic device without having a feeling of strangeness.

As has been described, use of interaction data having a data structure in accordance with an aspect of the present invention brings about the following effects.
(1) By storing, in a memory in advance, a minimum unit (interaction markup language) of an interaction, that is, a combination of an utterance content and an assumed response content, it is possible to effectively and quickly respond to an utterance inputted by a user. This makes it possible to adjust an amount of data pre-read or an amount of data processed in advance, depending on a capacity (for example, a CPU, a memory, and/or the like) of an electronic device which carries out such pre-reading or processing.
(2) In a case where a user makes, in a conversation, a response other than an assumed response, the conversation is regarded as being changed in topic. In this case, it is possible to search for appropriate interaction data in accordance with attribute information.
(3) Data is arranged so as to be comparatively small in size. It is therefore possible for even an electronic device having a low processing capacity to include the voice interactive system in accordance with Embodiment 1 or 2 and to have an interaction with a user.

Moreover, in a case where a conversation is continued by a user making a response, it is possible to continue the conversation by including, in the data structure, information indicative of data on such a continued conversation.

By pre-reading data on a response assumed from a conversation, it is possible to synthesize, for example, speech synthesis data in advance, and possible to hold the conversation at a good timing.

Therefore, according to an aspect of the present invention, by using, as interaction data, data having a data structure as illustrated in FIG. 2, it is possible to develop a voice interactive system (IVR: Interactive Voice Response) under an atmosphere under which a content of an interaction is likely to be changed, even in a case where a computer including a CPU which is not high in processing capacity is used.

Note that each of Embodiments 1 through 3 has described an example in which information is written in extended XML (see FIGS. 3 through 6) in interaction data. However, the present invention is not limited to such a format. Alternatively, the interaction data can be converted into another XML data or HTML data by XSLT, provided that the another XML data or the HTML data contains an identical constitutional element, that is, an identical response content which matches an utterance content and causes a conversation to be held. Alternatively, the interaction data can be converted into data in a simple textual description format such as a JSON (JavaScript® Object Notation) format or a YAML format. Alternatively, the interaction data can be in a specific binary format.

[Software Implementation Example]

A control block (in particular, the topic managing device 4 and the topic obtaining device 5) of each of the voice interactive systems 101 and 201 can be realized by a logic circuit (hardware) provided in an integrated circuit (IC chip) or the like or can be alternatively realized by software as executed by a central processing unit (CPU).

In the latter case, each of the voice interactive systems 101 and 201 includes: a CPU which executes instructions of a program that is software realizing the foregoing functions; a read only memory (ROM) or a storage device (each referred to as a “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Summary]

A data structure in accordance with a first aspect of the present invention is a data structure of data used by a voice interactive device (voice interactive system 101, 102) for a voice interaction, the data structure including a set of pieces of information, the set of pieces of information at least including: an utterance content (Speak) which is outputted with respect to a user (operator 1); a response content (Return) which matches the utterance content and causes a conversation to be held; and attribute information (Entity) indicative of an attribute of the utterance content.

According to the above configuration, it is possible to effectively and quickly respond to an utterance inputted by a user (operator 1). Furthermore, it is possible to adjust an amount of data pre-read or an amount of data processed in advance, depending on a capacity (for example, a CPU, a memory, and/or the like) of an electronic device which carries out such pre-reading or processing. Moreover, data is arranged so as to be comparatively small in size. It is therefore possible for even an electronic device having a low processing capacity to include a voice interactive system and to have an interaction with a user. Besides, even in a case where a topic of a conversation is changed, it is possible to search for and obtain an appropriate response content in accordance with attribute information indicative of an attribute of an utterance content.

Therefore, it is possible to have an interaction with a user at a comfortable timing without the need for a high processing capacity, and possible to continue the interaction even in a case where a topic of a conversation is changed.

The data structure in accordance with a second aspect of the present invention can be arranged such that, in the first aspect, the attribute information is made of a keyword in accordance with which another response content, further assumed from the utterance content, is specified.

The above configuration allows obtainment of data containing a response content appropriate for an utterance content. Therefore, even in a case where a topic of a conversation is changed, it is possible to continue the conversation with use of a more appropriate response content.

The data structure in accordance with a third aspect of the present invention can be arranged such that, in the first or second aspect, the set of pieces of information further includes data structure specifying information (e.g., Link To: A2. DML) which specifies another data structure (e.g., A2. DML) in which another utterance content (Speak) is registered, the another utterance content being relevant to the response content (Mean) which matches the utterance content and causes the conversation to be held.

The above configuration allows pre-reading of interaction data. It is therefore possible to carry out interactive processing without the need for a high processing capacity.

The data structure in accordance with a fourth aspect of the present invention can be arranged such that, in any one of the first through third aspects, the response content (Mean), which matches the utterance content and causes the conversation to be held, is registered in a form of voice data.

According to the above configuration, a response content is registered in the form of voice data. This does not require a process of converting text data into the voice data. That is, a processing capacity necessary to convert text data into the voice data is not needed. It is therefore possible to carry out interactive processing even with use of a CPU which is not high in processing capacity.

A voice interactive device in accordance with a fifth aspect of the present invention is a voice interactive device (voice interactive system 101, 201) which has a voice interaction with a user (operator 1), the voice interactive device including: an utterance content specifying section (topic managing device 4) which analyzes a voice uttered by a user and specifies an utterance content (Speak); a response content obtaining section (topic obtaining device 5) which obtains a response content (Return) from interaction data (e.g., A1. DML, A2. DML) registered in advance, the response content matching the utterance content, which the utterance content specifying section has specified, and causing a conversation to be held; and a voice data outputting section (topic managing device 4, voice synthesizing device 9, sound wave outputting device 10) which outputs, as voice data, the response content that the response content obtaining section has obtained, the interaction data having a data structure recited in any one of the first through fourth aspects.

According to the above configuration, it is possible to have an interaction with a user at a comfortable timing without the need for a high processing capacity, and possible to continue the interaction even in a case where a topic of a conversation is changed.

The voice interactive device in accordance with a sixth aspect of the present invention can be arranged so as to, in the fifth aspect, further include a storage device (file system 7) in which the interaction data is registered as a file.

According to the above configuration, the voice interactive device includes the storage device (file system 7) in which interaction data is registered as a file. It is therefore possible to promptly process a response to an utterance content.

The voice interactive device in accordance with a seventh aspect of the present invention can be arranged such that, in the fifth or sixth aspect, the content obtaining section obtains the interaction data from an outside of the voice interactive device via a network.

According to the above configuration, it is not necessary to provide, in the voice interactive device, a storage device in which interaction data is stored. It is therefore possible to reduce a size of an electronic device itself.

The voice interactive device in accordance with an eighth aspect of the present invention can be arranged so as to, in any one of the fifth through seventh aspects, further include a timer (11) which measures time that has elapsed from a time point when the voice interactive device obtained the voice uttered by the user, the voice data outputting section obtaining information on the time measured by the timer immediately before the voice data outputting section outputs the voice data, in a case where the voice data outputting section determines that the time measured by the timer is equal to or longer than preset time, the voice data outputting section outputting the voice data immediately after the voice data outputting section determines that the time measured by the timer is equal to or longer than the preset time, in a case where the voice data outputting section determines that the time measured by the timer is shorter than the preset time, the voice data outputting section outputting the voice data when the time measured by the timer reaches the preset time.

According to the above configuration, it is possible to adjust, with use of the timer, time until a sound wave is outputted, and accordingly possible to respond to a user at an appropriate timing. This makes it possible to hold a conversation at a good pace without causing a feeling of strangeness.

An electronic device in accordance with a ninth aspect of the present invention is an electronic device including a voice interactive device recited in any one of the fifth through eighth aspects.

It is possible to have an interaction with a user at a comfortable timing without the need for a high processing capacity. Even in a case where a topic of a conversation is changed, it is possible to continue the interaction.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an electronic device which is assumed, not only to be operated by a voice interaction, but also to have a general conversation with a user by a voice interaction. In particular, the present invention is suitably applicable to a home appliance.

### REFERENCE SIGNS LIST

1 operator (user), 2 voice collecting device, 3 voice recognizing device, 4 topic managing device, 5 topic obtaining device, 6 temporary storing device, 7 file system, 8 communication device, 9 voice synthesizing device, 10 sound wave outputting device, 11 timer, 101, 201 voice interactive system (voice interactive device), A1 through A6 interaction data (data used for voice interaction)

1. A data structure of data used by a voice interactive device for a voice interaction, the data structure comprising a set of pieces of information,
the set of pieces of information at least including:
an utterance content which is outputted with respect to a user;
a response content which matches the utterance content and causes a conversation to be held; and
attribute information indicative of an attribute of the utterance content.

2. The data structure as set forth in claim 1, wherein the attribute information is made of a keyword in accordance with which another response content, further assumed from the utterance content, is specified.

3. The data structure as set forth in claim 1, wherein the set of pieces of information further includes data structure specifying information which specifies another data structure in which another utterance content is registered, the another utterance content being relevant to the response content which matches the utterance content and causes the conversation to be held.

4. The data structure as set forth in claim 1, wherein the response content, which matches the utterance content and causes the conversation to be held, is registered in a form of voice data.

5. A voice interactive device which has a voice interaction with a user, the voice interactive device comprising:
an utterance content specifying section which analyzes a voice uttered by a user and specifies an utterance content;
a response content obtaining section which obtains a response content from interaction data registered in advance, the response content matching the utterance content, which the utterance content specifying section has specified, and causing a conversation to be held; and
a voice data outputting section which outputs, as voice data, the response content that the response content obtaining section has obtained,
the interaction data having a data structure recited in claim 1.

6. The voice interactive device as set forth in claim 5, further comprising a storage device in which the interaction data is registered as a file.

7. The voice interactive device as set forth in claim 5, wherein the response content obtaining section obtains the interaction data from an outside of the voice interactive device via a network.

8. The voice interactive device as set forth in claim 5, further comprising a timer which measures time that has elapsed from a time point when the voice interactive device obtained the voice uttered by the user,
the voice data outputting section obtaining information on the time measured by the timer immediately before the voice data outputting section outputs the voice data,
in a case where the voice data outputting section determines that the time measured by the timer is equal to or longer than preset time, the voice data outputting section outputting the voice data immediately after the voice data outputting section determines that the time measured by the timer is equal to or longer than the preset time,
in a case where the voice data outputting section determines that the time measured by the timer is shorter than the preset time, the voice data outputting section outputting the voice data when the time measured by the timer reaches the preset time.

9. An electronic device comprising a voice interactive device recited in claim 5.
